(19) United States
(12) Patent Application Publication
(10) Pub. No.: US 2006/0061082 A1
(43) Pub. Date: Mar. 23, 2006

(54) Pocket address book

(76) Inventor: Araceli Clemente Badillo, Los Angeles, CA (US)

Correspondence Address: Araceli C. Badillo, # 206, 725 S. Barrington Avenue, Los Angeles, CA, 90049, US

(21) Appl. No.: 10/945,024

(22) Filed: Sep. 20, 2004

(51) Int. Cl. B42D 1/00

(52) U.S. Cl. 281/15.1

(57) ABSTRACT

A combination address and business card book that utilizes a loose ring device to hold together a plurality of loose leaves/cards inside its end-covers. This book is pocket-portable, palm-handy, replaceable and/or refillable. The ring device may snap open/close for discarding or replacing outdated loose leaf/leaves/card/s in the book. The loose leaves/cards may include blank personal information carriers, business cards, and/or the like, combining personal and business information in one accessible system. One individual or business entity is assigned to each card. When information changes on a particular individual/business entity, the corresponding loose card is pulled out of the book to be discarded or replaced. Hence, outdated information never accumulates in this book. Additionally, the book conforms to the standard size of business cards, so its entirety can be held in the palm of one's hand, or kept inside a purse for maximum portability, and is conveniently accessed at anytime anywhere.

### BACKGROUND OF THE INVENTION

The field of the invention relates to address and business card book.

The present invention relates to an address book that is portable, handy, and refillable, in particular, held together by a single, openable ring device which allows for facile replacement and refill of one leaf/card or more, from a plurality of loose address book leaves/cards. The address book is pocket-portable, palm-handy, and can be carried in a purse or bag, in one's person at anytime, anywhere, or preferentially, on one finger looped through its loose ring device.

### DESCRIPTION OF THE PRIOR ART

The portable address books currently in the market today are typically bound together by spiral springs, 6-ring binders, or permanently bound with stitches or glue. These various address books also vary by their size, some small, some medium, some rather large and bulky. Usually, address books contain 5 to 10 names or more per page, to accommodate additions and/or changes to existing entries over time. As the personal information of an individual changes, the outdated information is simply crossed out or erased in the address book, and current information is written on another blank line, if space is still available. If all the lines/spaces in the address book are filled, which eventually occurs, new entries may be scribbled on the margin. Over time, such address books run out of blank lines/spaces, at which point the user must obtain another address book. As the new address book purchased is invariably similar in design to the prior book, the user must rewrite all names and addresses previously filed in the outdated address book, which task is known to be extremely tedious, definitely time-consuming, and to some totally irritating.

Electronic filing systems that are palm-handy are now popularly available but are cost-prohibitive to a huge population of users. There are also users who are intimidated by gadgets of modern technology or things digital; this address filing system invention offers a superior, simple, manual alternative to users.

Most notably, in all instances, the address books currently in the market today are not conveniently portable, refillable and/or replaceable all at the same time.

More so, these address books are not designed to combine personal cards with business cards, calling cards, membership cards, and the like.

Thus, an obvious need has arisen for a personal address book that also serves as a business card book, an address book that is both portable and refillable, one easily updated, and one that an individual can easily carry anywhere at anywhere, without it weighing too much or causing much inconvenience.

### SUMMARY OF THE INVENTION

It is the purpose of the present invention to provide a combination address and business card book that is portable, handy, refillable and/or replaceable, easy to carry anywhere at anytime, as well as easy to update and maintain current; as a combination address book that mixes personal and office business cards in a single file, contacts accessible at one's fingertips are expanded. Moreover, the address book is gathered together by a ring device or the like that is easy to snap, pry or pull or to unscrew to open, so that the loose address book leaves contained inside the address book are equally easy to remove or to replace.

### BRIEF DESCRIPTION OF THE DRAWINGS

A comprehensive understanding of the nature and objects of the present invention is rendered apparent upon consideration of the following detailed description taken in connection with the accompanying drawings, wherein:

FIG. 1.1 is a perspective view of a ring device, in its close option.

FIG. 1.2 is a perspective view of same ring device, in its open option.

FIG. 2.1 is a perspective view of the front surface of a personal information carrier . leaf/card, with a hole punched centered (or slightly off) on one edge.

FIG. 2.2 is a perspective view of the back/reverse surface of same card.

FIG. 3.1 is a perspective view of the front surface of a business card, with a hole punched centered (or slightly off) on one edge.

FIG. 3.2 is a perspective view of the back/reverse blank surface of same card.

FIG. 4 is a perspective view of a loose address book leaf/card in the process of being removed (or inserted) from the address book for replacement, (or filing) in a simple process of guiding the card out (or in) through the open ring device.

FIG. 5.1 is a perspective view of a closed address book, looking at the front end-cover and the exterior surface of a clasp device also in a closed position.

FIG. 5.2 is a perspective view of a closed address book, flipped, looking at the back end-cover and the exterior surface of the rest of the closed clasp device,

FIG. 6.1 is a perspective view of the exterior surface of a fastening device, the flap extended as it is pulled open from the front end-cover of the address book.

FIG. 6.2 is a perspective view of the interior surface of same fastening device, in the process of folding the book to close.

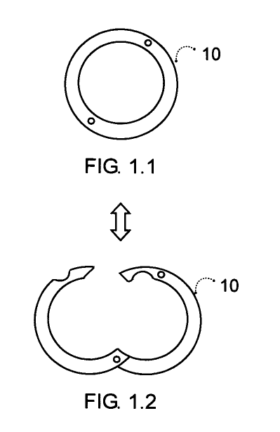

### DETAILED DESCRIPTION OF THE PREFERRED EMBODIMENT

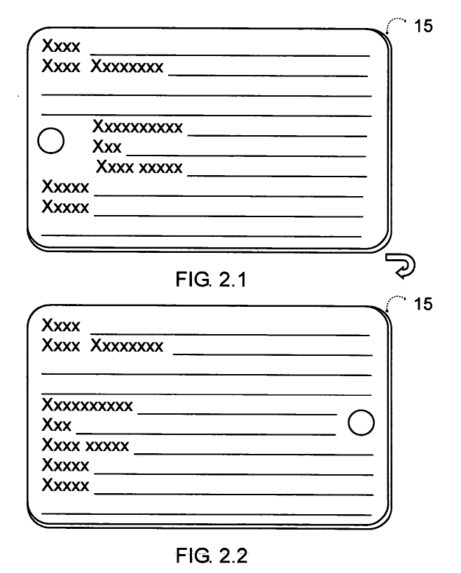

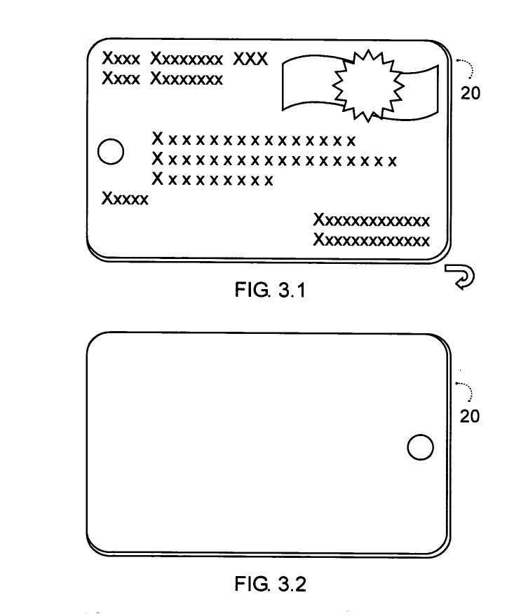

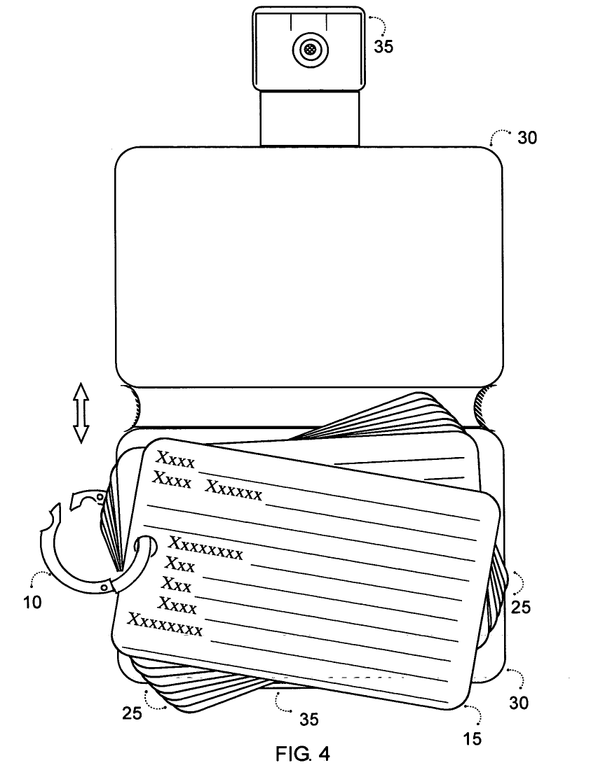

Referring now to the drawings, FIG. 4 shows the pocket address book that embodies the present invention. As hereinafter described, a single, openable loose ring device 10 or the like gathers the address book together. The plurality 25 of loose address book leaves/cards may consist of a blank personal information carrier 15 as shown in FIG. 2.1 and FIG. 2.2 and/or a business card 20, calling card, membership card or the like as shown in FIG. 3.1 and FIG. 3.2.

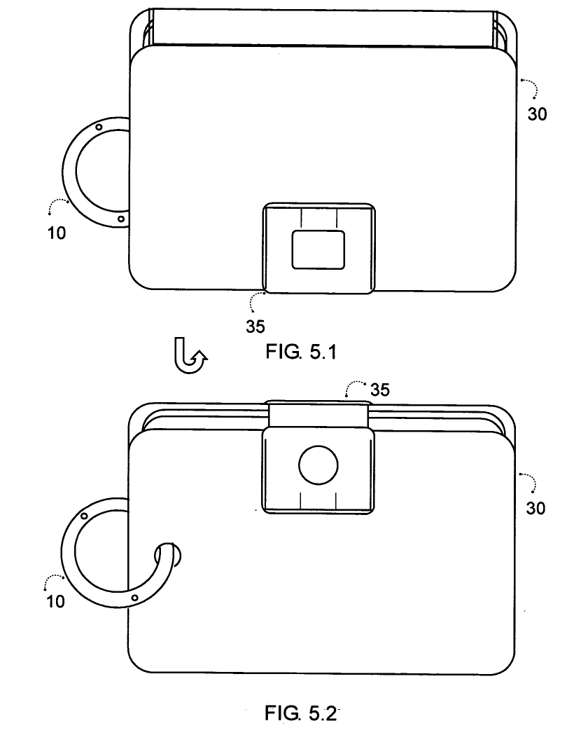

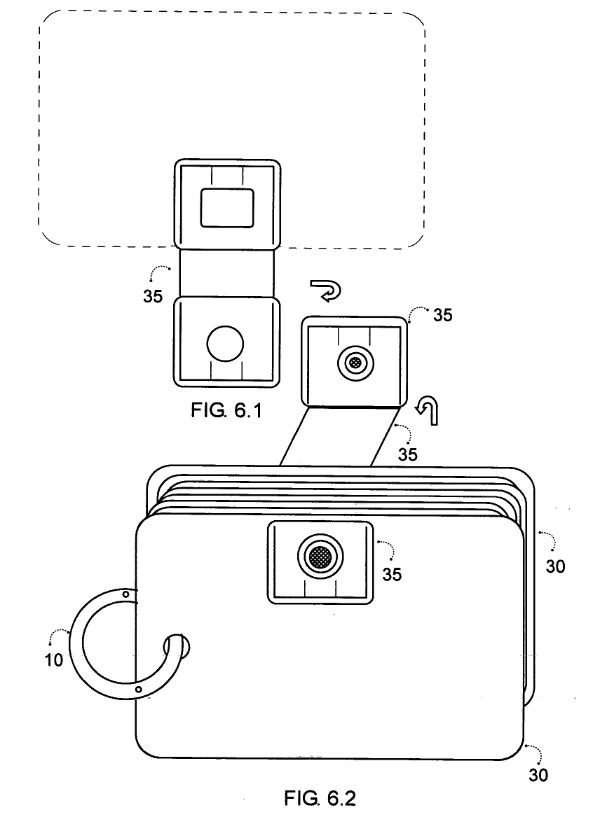

To discard or replace a loose address book leaf/card 15, the openable ring device 10 or the like is opened and the corresponding leaf/card 15 is removed through the ring device 10 or replaced with an updated card by simply inserting it through the open ring device 10, as is also demonstrable in FIG. 4. After the loose address book leaf/card 15 is removed or replaced, the openable ring device 10 is then closed; the address book end-covers 30 are closed together, shown in FIG. 5.1 and FIG. 5.2, then kept secured by the fastening device 35 as shown in FIG. 6.1 and FIG. 6.2.

As can be deduced, the pocket address book of this present invention has a couple of economic hallmarks: first, that it is relatively simple to manufacture, and second, that the cost of its mass production will not be extreme; its cost to the consumers, therefore, will be more affordable than current alternatives.

Since certain changes may be made in the foregoing disclosure without departing from the scope of the invention herein involved, it is intended that all matter contained in the above description and depicted in the accompanying drawings be construed in an illustrative but not in a limiting sense.

I claim:

1. A combination address and business card book that is pocket-portable, palm-handy, readily accessible, replaceable and/or refillable, comprised of:
(a) a single, openable, loose ring device or the like
(b) a plurality of loose, blank personal address cards and printed business cards or similar vital information carriers such as club membership cards
(c) a set of address book end-covers, with the front and back surfaces both attached to a common spine, to contain in totality the girth of the book
(d) a fastening device utilizing either clasps, elastics, buttons, magnets or zippers

2. The openable, loose ring device or the like as claimed in claim 1 is snapped, pried, pulled or unscrewed to open; the reversal of each said step closes same ring device.

3. The plurality of loose address book leaves or cards as claimed in claim 1 may include blank personal information carriers, pre-printed business cards, calling cards, membership cards, calendar, memo or schedule cards, and the like.

4. The blank loose personal information carriers as claimed in claim 3 are printed with specific designations and aligned segments provided to serve as guide-marks for inputting handwritten data with ease, on both its front and back surfaces; said each personal information carrier is allotted to one individual or one business entity per leaf or card; this restricts the impact of address changes in only one individual, or one business entity to only one card at a time. Equivalently, only one card shall require replacement, leaving in place all remaining current cards; as such the useful integrity of said pocket address book is retained and protected through its lifetime.

5. The loose blank personal information carriers as claimed in claim 4 are all purposely and uniformly sized to the standard size of regular calling and business cards, or the like, per current market practice, to ensure cosmetic and functional integrity, allowing other similar cards to be incorporated in this book.

6. Each of the loose address book leaf/card as claimed in claim 1 bears a punched hole centered (or slightly off) on the left edge of the front surface of the card; when flipped, the punched hole necessarily appears on the right edge of its back surface.

7. The pre-printed business cards as claimed in claim 3 may include personal or office business cards collected from acquaintances, personal friends, business associates or professional colleagues; the reverse surfaces of these cards are usually devoid of information and therefore are generally blank.

8. The calling cards, membership cards or the like as claimed in claim 3 include generic cards issued by business establishments, e.g., hotels, casinos, airlines, rental companies, health providers, or personal calendars, daily memo cards, etc.

9. The address book back end-cover as claimed in claim 1 bears a punched hole close to its left edge; said punched hole is centered (or slightly off) on this edge and is aligned to the individual punched holes on the plurality of loose address book leaves/cards as claimed in claim 6. The front end-cover is not punched with a hole.

10. The address book end-covers, as claimed in claim 1, loosely gather, contain, protect the plurality of the address book leaves/cards collected therein.

11. The address book end-covers as claimed in claim 1 are sized to be slightly, but not significantly, bigger than the size of the book leaves or cards contained therein; this margin is intended to allow for an appropriate buffer space that prevents the cards and their edges from being frayed or from constantly snagging against the closing device, a zipper or otherwise, when opened and closed.

12. The fastening device as claimed in claim 1 secures the plurality of loose address book leaves/cards and their end-covers in a flexible enclosure, that is, specifically, without any permanent binding.

13. The pocket-portable, palm-handy, replaceable and/or refillable combination address and business card book ensemble, is assembled thus:
(a) a ring device or the like is first opened, then said ring device is inserted through the punched hole on the address book back cover; once secured in place, each loose leaf/card is fed either singly or in groups, into the open loop of the ring device, through each similarly located punched hole/s in the card/s, so that they consist a plurality; said loose ring device allows each individual address book leaf/card to be turned all the way to the opposite end of the ring device in its closed position, so that one or more cards can be temporarily packed towards or rested on the book front end-cover while the other portion can be supported on its back end-cover, either when needing to write information into the card or for momentary perusal of the information on the card; crucial of said ring device or the like is the facility of the process of opening and closing it, which then allows each loose address book leaf/card to be equally easily removed from and/or replaced, or added to the address book.
(b) individual cards from this plurality of loose address book leaves/cards are, therefore, by this design, easily removed, discarded and/or replaced from the card file ensemble through the openable ring device, as described in (a), when personal data, business information or vital details of an individual or a business entity change.
(c) this plurality of loose address book leaves/cards held together by an openable ring device is then contained in a set of address book end-covers, both end-covers connected to a common spine so that the card plurality is held stable while in use or while stored, despite that the plurality is not permanently bound together, in contrast to the manner of available address books prevailing in today's market.
(d) the entire pocket-portable combination card book is then fully closed with a fastening device that may consist of either clasps, buttons, elastics, magnets, or zippers, each device characteristically quick to open or close when in use; conversely, when stored, same fastening device secures, gathers, holds together, and protects the plurality of cards from random or accidental scatter.

14. This combination pocket-portable, palm-handy, replaceable and/or refillable address and business card book, by its simplicity of design and conformity of size to prevailing standard cards, can be carried in one's person anywhere and everywhere with comfort and flexibility, as said combination address book can readily fit inside one's pocket, anyone's purse or bag, and even snugly carried in the palm of one's hand, and/or per preference, as well as looped over a finger through its solitary loose ring device.
